(19) United States
(12) Patent Application Publication
(10) Pub. No.: US 2001/0009249 A1
(43) Pub. Date: Jul. 26, 2001

(54) Metal etching process

(76) Inventors: Wen-Pin Kuo, Hsinchu (TW); Yueh-Feng Ho, Hsinchu Hsien (TW); Jy-Hwang Lin, Kaohsiung City (TW)

Correspondence Address: J.C. Patents, 1340 Reynolds, Ave., Suite 114, Irvine, CA, 92614, US

(21) Appl. No.: 09/815,801

(22) Filed: Mar. 23, 2001

Related U.S. Application Data
(62) Division of application No. 09/326,380, filed on Jun. 4, 1999.

(51) Int. Cl. B44C 1/22; C23F 1/00

(52) U.S. Cl. 216/72; 216/63; 216/75; 216/76

(57) ABSTRACT

A metal etching process. A glue/barrier layer, a metal layer and an anti-refeletion layer are formed on a substrate. A three-stage etching step is performed. A break through step of etching is performed to pattern the glue/barrier layer. A main etching step is performed on the metal layer with chlorine, boron trichloride, and trifluoro-methane as etching gases. The trifluoro-methane is advantageous to produce a polymer during etching, so that the profile of the metal layer appears atilt. An over-etching step is then performed to ensure an insulation between neighboring wiring lines.

### BACKGROUND OF THE INVENTION

1. Field of Invention

The present invention relates to a method of metal etching process. More particularly, the present invention relates to a method of preventing from resulting an I-shape profile of a metal after being etched.

2. Description of Related Art

In a conventional method for forming a wiring line, due to the different rates between an anti-reflection layer, aluminum layer and glue/barrier layer, a surface of the aluminum layer is often indented inwardly while the aluminum layer is etched after the anti-reflection layer. The inward indent result in an I-shape profile of the aluminum layer, that is, the resultant width of the anti-reflection layer is larger than that of the aluminum layer. In the subsequent etching process for forming an unlanded contact or via, an oxide layer deposited adjacent to a sidewall of the aluminum layer is difficult to remove, so as to induce a shield of the aluminum layer. The shield of the aluminum layer would further cause the formation of an oxide spacer between the glue/barrier layer and a metal layer formed afterwards. As a consequence, the contact resistance of the wiring line is greatly increase to affect the performance of the whole circuit seriously.

Another conventional to resolve the problem of the increased contact resistance described as above includes using performing a high density plasma (HDP) etching step on the oxide layer to form the opening for the via or contact. When the anti-reflection layer is exposed in the opening, the high density plasma etching step has a corner cutting function whenever a corner of the anti-reflection layer is formed. Thus, the oxide layer deposited on the sidewall of the aluminum layer is easily removed. A conductive material to fill the opening in the subsequent process is therefore highly conductive to the exposed aluminum layer. However, the high density plasma etcher is very expensive, so that the cost of the etching process is high.

### SUMMARY OF THE INVENTION

The invention provides a metal etching process. A substrate comprising a glue/barrier layer, a metal layer and an anti-reflection layer is provided. A three-stage etching step is performed. The first stage comprises a break through etching step to pattern the glue/barrier layer. In the second stage, a main etching step is performed on the metal layer with chlorine (Cl₂), boron trichloride (BCl₃) and trifluoro-methane (CHF₃) as etching gases. The profile of the metal layer thus appears atilt. In the third stage, an over etching step is performed.

As embodied and broadly described herein, the invention provides a method for etching a metal layer. The metal layer may be formed of material such as aluminum or aluminum alloy. In the main etching step, the flow rate of chloride is controlled between about 70 to about 100 sccm, while the flow rates of boron trichloride and trifluoro-methane are at about 40 to about 60 sccm and no larger than 10 sccm. respectively. The pressure, source power, bias of the main etching are controlled at about 10-15 mtorr, 800-1200 W and 100-200 W. For the break through etching step, chlorine is used as the etching gas first with a flow rate of about 50-150 sccm. The operating pressure, source power and bias are at about 12-18 mtorr, 1500-2000 W and within about 50 W, respectively. The main etching step is then continued with chlorine, boron trichloride, trifluoro-methane as etching gases having flow rates of about 40-80 sccm, while the operating pressure, source power and bias are controlled at about 6-10 mtorr, 600-800 W and 100-200 W. In the over etching step, chlorine and boron trichloride are used as etching gases with flow rates controlled at about 50-70 sccm and 40-60 sccm. The operation conditions of the over etching step comprise a pressure of about 10-15 mtorr, a power of about 800-1200 W and a bias of about 100-150 W.

With the introduction of trifluoride methane, polymer is produced during the etching step. The polymer is adsorbed on a surface of the metal layer to avoid from inwardly recessing the metal layer during the over etching step. On the contrary, a tilt sidewall of the metal layer is resulted after being etched. The width of the metal layer is thus no narrower than the width of the anti-reflection layer. The tilt profile of the metal layer is advantageous to the subsequent process for forming contact or via opening and plug.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A to FIG. 1C shows a preferred embodiment of etching a metal layer according to the invention.

### DESCRIPTION OF THE PREFERRED EMBODIMENTS

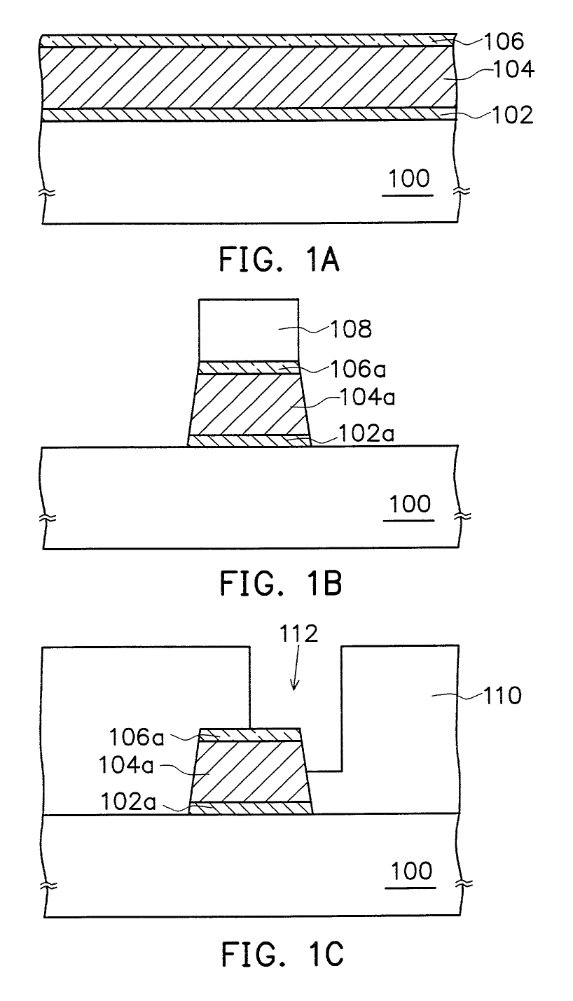

In FIG. 1C, a substrate 100 is provided. The substrate 100 comprises, for example, a silicon substrate having devices such as a metal-oxide semiconductor transistor or components (not shown) formed thereon. A glue/barrier layer 102, for example, a titanium nitride layer or a stack of titanium/titanium nitride, is formed on the substrate 100. A metal layer 104 such as a layer of aluminum or aluminum alloy is formed on the glue/barrier layer 102. An anti-reflection layer 106, for example, a silicon oxy-nitride layer/titanium nitride layer, is formed on the metal layer 104.

In FIG. 1B, a patterned photo-resist layer 108 is formed on the anti-reflection layer 106. Using the photo-resist layer 108 as a mask, a three-stage etching step is performed to for conductive wires. In a first stage, a break through etching step is performed on the anti-reflection layer 106. A second stage includes a main etching step to strip off a part of the metal layer 104. A third stage includes an over etching step to remove a part of the glue/barrier layer 102 to ensure an isolation between neighboring conductive wires. After being etched, the remaining glue/barrier layer, metal layer and anti-reflection layer are denoted as 102a, 104a and 106a.

In the first stage of the etching step, that is, the break through etching step, chlorine is used to etch silicon oxy-nitride if the anti-reflection layer 106a is made of silicon oxy-nitride/titanium nitride. The flow rate is controlled at about 50-150 sccm. The pressure of reacting chamber is at about 12-18 mtorr, while a source power of about 1500-2000 W and a bias within about 50 W are applied. The titanium nitride is then etched using a mixture of etching gases comprising chlorine, boron chloride and trifluoro-methane with flow rates of about 40-80 sccm. A source power of about 600-800 W and a bias of about 100-200 W are applied to the reaction chamber with a operating pressure of about 6-10 mtorr.

In the second stage of the etching step, that is, the main etching step, to etch a metal layer made of aluminum or aluminum alloy, etching gases including chlorine, boron trichloride and trifluoro-methane are used with flow rates of about 70-100, 40-60 and within 10 sccm, respectively. The reaction chamber is controlled to have an operating pressure, a source power and a bias power of about 10-15 mtorr, 800-1200 W and 100-200 W, respectively.

In the main etching stage, polymer is produced with the introduction of trifluoride methane. The polymer is adsorbed on an exposed surface of the metal layer 104a. The recess caused by the conventional method on a sidewall of the metal layer is thus avoided. In contrast, the remaining metal layer 104a has a sloped sidewall and a profile of gradually widening from a top surface to a bottom surface thereof. That is, the top surface adjacent to the remaining anti-reflection layer 102a having a cross section smaller than the bottom surface adjacent to the glue/barrier layer 102a. The remaining metal layer 104a thus has the sloped sidewall outstanding the anti-refelction layer laterally.

Chlorine and boron trichloride are used as etching gases in the third stage of the etching, that is, the over etching step. The chlorine has a flow rate controlled at about 50 to about 70 sccm, while the boron trichloride has an etching rate of about 40 to about 60 sccm. The reacting chamber to perform the over etching step is controlled with an operation pressure, a source power and a bias of about 10-15 mtorr, 800-1200 W and 100-150 W.

In FIG. 1C, the photo-resist layer 108 is removed. An insulation layer 110 is formed to cover the substrate 100 and a conductive wire concluding the glue/barrier layer 102a, the metal layer 104a and the anti-reflection layer 106a. The formation of the insulation layer 110 is to ensure insulation from other conductive wire formed on the substrate 100. A contact opening 112 is formed in the insulation layer 110 to expose at least a part of the conductive wire. In certain circumstance, the metal layer 104a as well as the anti-reflection layer 104a are to be exposed to achieve an electrical connection. As shown in FIG. 1C, the metal layer 104a can be exposed easily as required due to the sloped sidewall. Thus, in a subsequent process for filling the opening 112 with a plug, a good contact between the plug and the metal layer 104a is achieved. Consequently, the conductive performance of the devices is highly upgraded.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A metal etching process, comprising:
providing a substrate comprising a glue barrier layer on the substrate, a metal layer on the glue/barrier layer and an anti-reflection layer on the metal layer; and
patterning the anti-reflection layer, the metal layer and the glue/barrier layer to result in a sloped sidewall of the metal layer which has a larger top surface adjacent to the anti-reflection layer and a smaller bottom surface adjacent to the glue/barrier layer.

2. The metal etching process according to claim 1, wherein the anti-reflection layer comprises a silicon oxy-nitride/titanium nitride layer.

3. The metal etching process according to claim 2, wherein the anti-reflection layer is patterned by etching the silicon oxy-nitride with chlorine as an etching gas and etching the titanium nitride chlorine with a mixture of chlorine, boron trichloride and trifluoro-methane as etching gas.

4. The metal etching process according to claim 3, wherein the etching gas of chloride has a flow rate of about 50-150 sccm, while chlorine, boron trichloride and trifluoro-methane of the mixture each has a flow rate of about 40-80 sccm.

5. The metal etching process according to claim 3, wherein the silicon oxy-nitride is etched with conditions of an operation pressure at about 12-18 mtorr, a source power of about 1500-2000 W, and a bias within a range of 50 W.

6. The metal etching process according to claim 3, wherein the titanium nitride is etched with conditions of an operation pressure at about 6-10 mtorr, a source power of about 600-800 W, and a bias within at about 100-200 W.

7. The metal etching process according to claim 1, wherein the metal layer comprises a layer of aluminum or aluminum alloy.

8. The metal etching process according to claim 7, wherein the metal layer is patterned by an etching step with a mixture of chlorine, boron trichloride and trifluoromethane as an etching gas.

9. The metal etching process according to claim 8 wherein flow rates of chlorine, boron-trichloride and trifluoro-methane are controlled at about 70-100 sccm, 40-60 sccm and less than or equal to 10 sccm, respectively.

10. The metal etching process according to claim 8, wherein the etching step is controlled with a pressure of about 10-15 mtorr, a source power of about 800-1200 W and a bias of about 100-200 W.

11. The metal etching process according to claim 8, wherein an over etching step is further performed on the metal layer and the glue/barrier layer after the etching the metal layer with a mixture of chlorine and boron trichloride as an etching gas.

12. The metal etching process according to claim 11, wherein flow rates of chlorine and boron trichloride are controlled at about 50-70 sccm and 40-60 sccm, respectively.

13. The metal etching process according to claim 11, wherein the over etching step is performed in a reaction chamber having a pressure of about 10-15 mtorr and applied with a source power of about 800-1200 W and a bias of about 100-150 W.

14. The metal etching process according to claim 1, comprising further the steps of:
forming an insulation layer on the substrate and covering the anti-reflection layer, the metal layer and the glue/barrier layer; and
forming an opening in the insulation layer to expose at least a part of the anti-reflection layer and the metal layer.

15. A metal etching process, comprising:
providing a substrate having a metal layer covered by an anti-reflection layer thereon;
performing a break through etching step on the anti-reflection layer;
performing a main etching step on the metal layer, wherein a polymer is produced and adsorbed by a surface of the metal layer wherever is exposed during the main etching step; and
performing an over etching step.

16. The metal etching process according to claim 15, wherein the metal layer is formed of aluminum or aluminum alloy.

17. The metal etching process according to claim 16, wherein trifluoromethane is used for the main etching step, so that the polymer is produced to cover the exposed surface of the metal layer during the main etching step.

18. The metal etching process according to claim 15, comprising further the steps of:
forming an insulation layer on the substrate and covering the anti-reflection layer, the metal layer; and
forming an opening in the insulation layer to expose at least a part of the anti-reflection layer and the metal layer.

19. A metal etching process, comprising:
providing a substrate having a metal layer thereon and an anti-reflection layer on the metal layer;
performing a three-stage etching process on the metal layer and the anti-reflection layer to form a conductive wire, the three-stage etching process further comprising:
performing a first etching step on the anti-reflection layer;
performing a main etching step on the metal layer with an etching gas which produces a polymer covering an exposed surface of the metal layer during the main etching step; and
performing an over etching step without using the etching gas which produces the polymer;
forming an insulation layer to cover the substrate and the conductive wire; and
forming an opening filled exposing a part of the conductive wire.

20. The metal etching process according to claim 18, wherein the conductive wire comprising the etched metal layer with a gradually widening profile from a top surface towards a bottom surface thereof.

21. The metal etching process according to claim 18, wherein the etched metal layer has a sloped sidewall outstanding the anti-reflection layer in lateral direction.
